(19) United States
(12) Patent Application Publication
(10) Pub. No.: US 2014/0160295 A1
(43) Pub. Date: Jun. 12, 2014

(54) ROAD CONDITION DETECTION

(71) Applicant: HONDA MOTOR CO., LTD., Tokyo (JP)

(72) Inventors: Tatsuya Kyomitsu, Oyama-shi (JP); Naoki Sugimoto, Sunnyvale, CA (US)

(73) Assignee: HONDA MOTOR CO., LTD., Tokyo (JP)

(21) Appl. No.: 13/707,017

(22) Filed: Dec. 6, 2012

(51) Int. Cl. G08G 1/0967

(52) U.S. Cl. CPC G08G 1/0967
USPC 348/159; 340/905

(57) ABSTRACT

Systems and methods of detection and notification of potential road conditions are disclosed herein. One such method can include the acts of receiving a first set of data associated with the location on the road surface from a first vehicle and identifying a first subset of the first set of data. The first subset can be associated with the potential road condition. The method can also include the acts of calculating a probability associated with the potential road condition based at least in part on the first subset, determining whether the probability exceeds a threshold, and notifying at least one vehicle of the potential road condition when the probability exceeds the threshold upon the at least one vehicle approaching the location.

### BACKGROUND

Drivers on roads can encounter a variety of detrimental road conditions that can be potentially hazardous to vehicles or occupants, such as potholes, objects in the road, uneven road surfaces, etc. Conventionally, driver awareness of road conditions either arises through observation by the driver of the road condition directly or through other vehicles responding, or through conventional sources such as radio traffic reports. However, these conventional methods frequently provide inadequate notice to drivers in order to avoid detrimental road conditions, resulting in avoidable harm to vehicles and occupants.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

This disclosure, in one aspect thereof, includes a method of detection and notification of potential road conditions. One such method can include receiving a first set of data associated with the location on the road surface from a first vehicle and identifying a first subset of the first set of data. The first subset can be associated with the potential road condition. The method can also include calculating a probability associated with the potential road condition based at least in part on the first subset, determining whether the probability exceeds a threshold, and notifying at least one vehicle of the potential road condition when the probability exceeds the threshold upon the at least one vehicle approaching the location.

In another aspect of the disclosure, a system can be included that facilitates identification of a potential road condition associated with a road surface. Such a system can include one or more vehicles. At least a first vehicle of the one or more vehicles can collect data associated with the potential road condition via one or more sensors. The data can include an approximate location of the potential road condition. Additionally, the system can include one or more remote servers. The one or more remote servers can receive a first subset of the data collected by the at least the first vehicle, and the one or more remote servers can determine a probability associated with the potential road condition based at least in part on the first subset. The one or more remote servers can additionally provide a notification to at least a second vehicle when the probability exceeds a threshold value.

To the accomplishment of the foregoing and related ends, certain illustrative aspects of the disclosure are described herein in connection with the following description and the annexed drawings. These aspects are indicative, however, of but a few of the various ways in which the principles of the disclosure can be employed and the subject disclosure is intended to include all such aspects and their equivalents. Other advantages and novel features will become apparent from the following detailed description of the disclosure when considered in conjunction with the drawings.

### BRIEF DESCRIPTION OF THE DRAWINGS

FIG. 1 illustrates an example system that facilitates detection and sharing of road condition information in accordance with aspects of the disclosure.

FIG. 2 illustrates an example vehicle in accordance with various aspects of the disclosure.

FIG. 3 illustrates an example a method of identifying potential road conditions in accordance with aspects of the disclosure.

FIG. 4 illustrates a block diagram of a computer operable to execute the disclosed architecture.

FIG. 5 illustrates a schematic block diagram of an exemplary computing environment in accordance with the disclosure.

### DETAILED DESCRIPTION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

As used in this disclosure, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

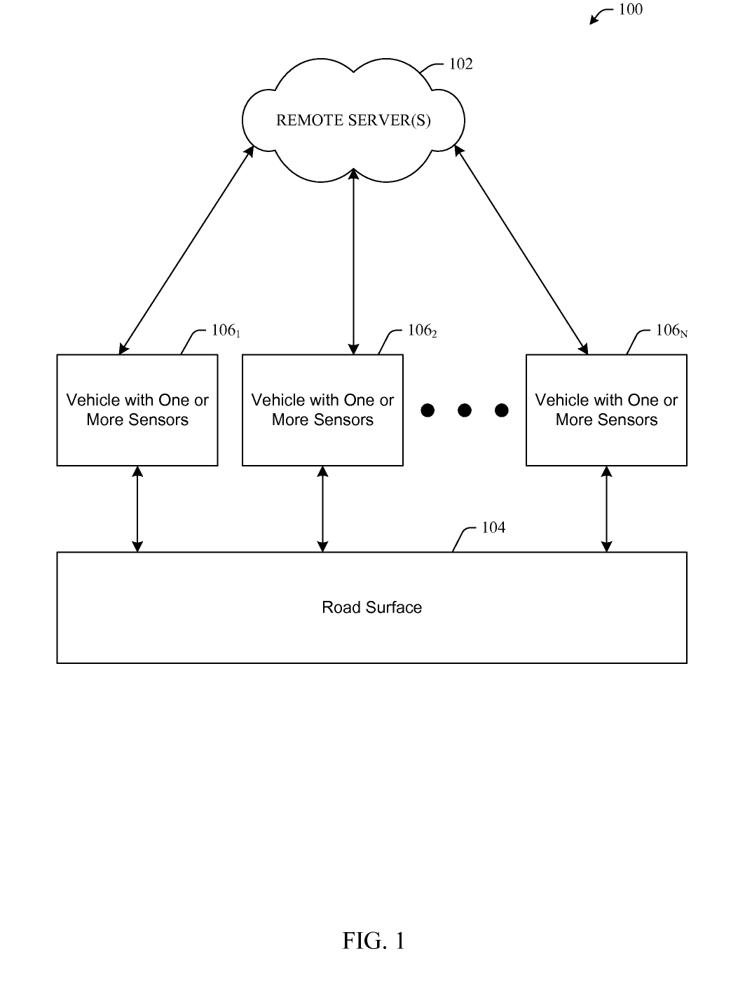

Referring initially to the drawings, FIG. 1 illustrates a system 100 that facilitates detection and sharing of road condition information in accordance with aspects of the disclosure. System 100 can include one or more remote servers 102 (e.g., cloud computing, etc.) that can receive data associated with potential road conditions (e.g., potholes, objects in the road, etc.) on a road surface 104 from a first subset of one or more vehicles 106, can analyze the data (or subset thereof), and can provide the results of that analysis to a second subset (that may or may not overlap with the first subset) of the one or more vehicles 106. Each of the one or more vehicles 106 can include at least one sensor that can be used to collect information regarding road conditions as described herein. It is to be understood that different vehicles 106 can include different sensors, or types of sensors, such as sensors that can obtain data based on the road surface 104, sensors that can obtain data based on the vehicle 106 (e.g., performance, shock, vibration) or other sources (e.g., user input, other vehicles, etc.), or sensors that can obtain data from both. These sensors can collect data associated with one or more potential road conditions (e.g., potholes, objects in the road, etc.) on a road surface 104, and the vehicle 106 can provide at least a subset of this data to the one or more remote servers 102. Location data can be associated with the sensor data, such that the potential road conditions can be associated with specific locations. In aspects, time data can also be associated with the sensor data, which can be used in various ways as described herein, e.g., because road conditions (e.g., potholes, obstacles, etc.) are subject to change over time, more recent data can receive greater weight in determining the likelihood of potential road conditions.

It is to be appreciated that, in other aspects, data can be stored locally and transmitted at a later time. For example, data can be transmitted based upon a scheduled interval (e.g., batch) as desired.

A subset of the collected data can be selected or otherwise tagged as relating to one or more potential road conditions. For example, vertical acceleration of a vehicle 106, e.g., as determined by a G sensor, can be caused by potholes or objects in roads. Thus, such data can be selected or tagged as related to a potential road condition. This selection can take place at the one or more vehicles 106, at the one or more remote servers 102, or both. The selected data can be analyzed by the one or more remote servers 102 to determine one or more potential road conditions. The one or more remote servers 102 can assign a likelihood to the one or more road conditions. The likelihood can be based on a number of factors, such as the type, quantity, or time of data associated with a potential road condition. For example, if data associated with a potential road condition is received from more than one vehicle, the likelihood can increase. In a different example, if a location is associated with a potential road condition, but more recent data indicates no such potential road condition (e.g., a potential pothole was previously detected, but more recent video information indicates it may not be there anymore), the likelihood can decrease.

If the likelihood of a potential road condition associated with a location exceeds a threshold value, the one or more remote servers 102 can provide an alert or notification to vehicles 106 that approach the location indicating that a potential road condition exists. In aspects, additional information associated with the potential road condition can also be provided, such as data associated with the condition (e.g., visual data such as photographic or video data, etc.), a visual or auditory indicator, a likely identification of the condition (e.g., pothole, object obstructing lane, etc.), etc. In aspects, changes in the likelihood of a condition based on data obtained from vehicles 106 that received an alert can be based at least in part on the alert. Such vehicles may be more likely to measure different data, such as due to the potential for actions by a driver to affect data from some but not all sensors based on the alert (e.g., such a driver may be less likely to hit the pothole, etc., thus less likely to register the potential condition via vertical acceleration recorded by a G sensor, although camera data may be unaffected, and horizontal acceleration may be more likely, for example to avoid the condition, etc.).

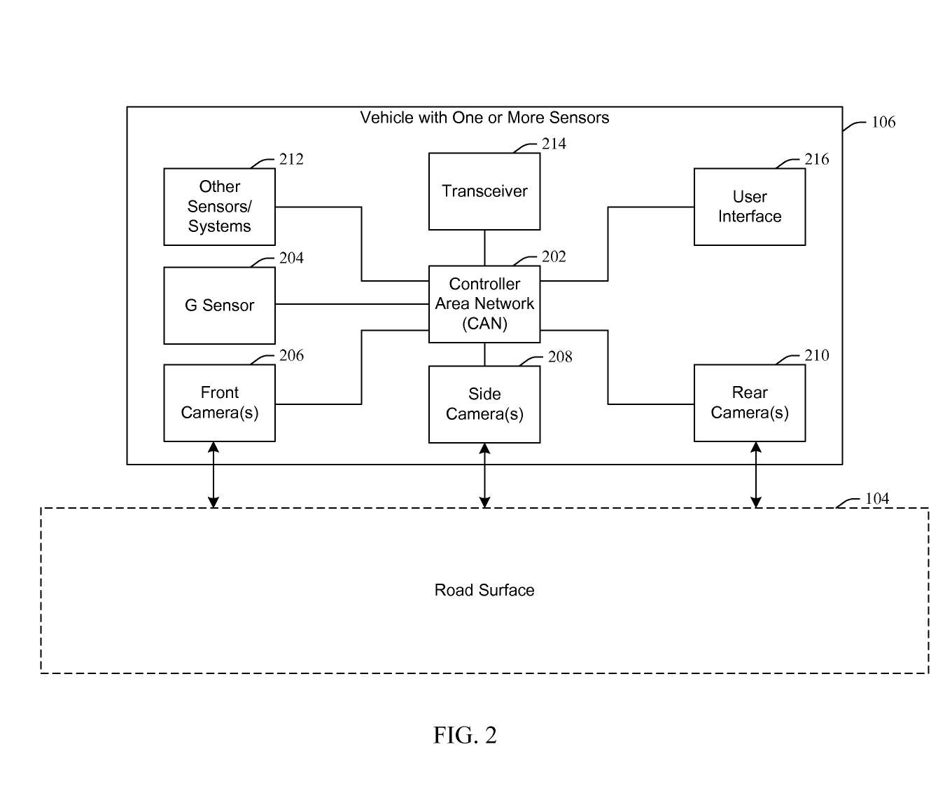

FIG. 2 illustrates an example vehicle 106 in accordance with various aspects of the disclosure. Example vehicle 106 can include a controller area network (CAN) 202 or vehicle computer that can facilitate communication between the components of vehicle 106 (reference to a CAN herein is to be understood to include reference to a computer or similar device that can also be used). Vehicle 106 can also include a G sensor 202 that can measure acceleration in a plurality of directions (e.g., vertically, forwards or backwards, left or right, etc.). In addition, vehicle 106 can include one or more cameras that can collect or record visual data of the road surface 104, such as at least one front camera 206 (e.g., which can be used in connection with a lane keep assist system (LKAS), etc.), at least one side camera 208, or at least one rear camera 210. Each of the cameras 206-210 can be used to monitor potential road conditions on the road surface 104 (e.g., potholes, objects in the road, etc.). Additionally, individual cameras can be used to verify readings or detection of others, for example, a rear camera 210 can be used to verify detection of a front camera 206. While the cameras 206-210 are pointed in a downward direction, they may be pointed at an angle and read the road surface 104 at the angle. Furthermore, other cameras may be used and detect conditions for the road surface 104 on adjacent lanes.

In addition to direct monitoring of potential road conditions, the cameras 206-210 can also collect data that may correlate with potential road conditions, such as the motion of other vehicles (e.g., braking, swerving, vertical motion, etc.), the presence of traffic cones or signs, etc. One or more other sensors or systems 212 can also be included to collect additional data that that may correlate with potential road conditions, for example a rangefinder (or other capable device) to determine the distance to the ground under the vehicle (which could vary based on the presence or absence of potholes or objects), location determination (e.g., via Global Positioning System (GPS), cell phone towers, etc.), time measurements associated with data (e.g., to synchronize data, to determine if road conditions have been remedied, etc.), vehicle speed, yaw rate, etc. Location and time data can be associated with data collected by systems and sensors 204-212 (and/or user interface 216) to associate potential road conditions with specific locations, and to synchronize data collected from each of 204-212 and/or user interface 216). A subset of the data collected by sensors and systems 204-212 and/or user interface 216 (i.e., none, some, or all) can be transmitted to one or more remote servers (e.g., remote servers 102, etc.) via a transceiver 214. If less than all of the data is transmitted, a determination can be made (e.g., by CAN or computer 202, etc.) as to which data to transmit, e.g., based on the likelihood of data being associated with a potential road condition.

Based on the subset of the data received, the subset can be analyzed and a determination can be made (e.g., at the one or more remote servers 102, etc.) as to whether one or more potential road conditions are associated with a probability above a threshold value. If one or more potential road conditions are determined to have a probability above the threshold value, an alert or notification can be sent to vehicles such as vehicle 106 when approaching the location associated with the potential road condition(s), which can be received via transceiver 214 (as discussed elsewhere herein, an alert or notification can also be sent to an entity responsible for maintenance of the road surface 104). A user interface 216 can be included that can provide a driver with alerts or notifications of potential road conditions before the driver reaches them. Additionally, user interface 216 can also be employed by users to provide data on potential road conditions, e.g., via a button press, verbally, via gesture, etc.

The data collected by sensors and systems 204-212 (and potentially input via user interface 216) can be used in a variety of ways to determine one or more potential road conditions. For example, acceleration data from G sensor 204 can be used to detect potential road conditions in a variety of ways. Vertical acceleration, either up or down, can be indicative of a pothole, object in the road, etc. Camera data before (e.g., from front camera 206) or after (e.g., from rear camera 208) the time of the acceleration data can be used in connection with acceleration data. Rearward acceleration (e.g., from braking, etc.) can be indicative of a road condition (or other situations, e.g., traffic, stop signs, traffic lights, etc.) in front of the vehicle 106, which can be supported (or contradicted) by data from cameras 206-210. Acceleration to either side can also be associated with a road condition (e.g., that the driver swerves to avoid) or with other situations, and data from cameras 206-210 can further assist in determination of whether or not a potential road condition exists. Camera data can be used for visual identification of potential road conditions either directly (e.g., through pictures or footage of potholes, objects in the road, etc.) or indirectly (e.g., via other vehicles, signs, etc.). Input from a driver via user interface 216 or data from other sensors or systems 212 can also be used in conjunction with other data to assist in or enhance determination of potential road conditions.

While, for purposes of simplicity of explanation, the one or more methodologies shown herein, e.g., in the form of a flow chart, are shown and described as a series of acts, it is to be understood and appreciated that the disclosure is not limited by the order of acts, as some acts may, in accordance with the disclosure, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the disclosure.

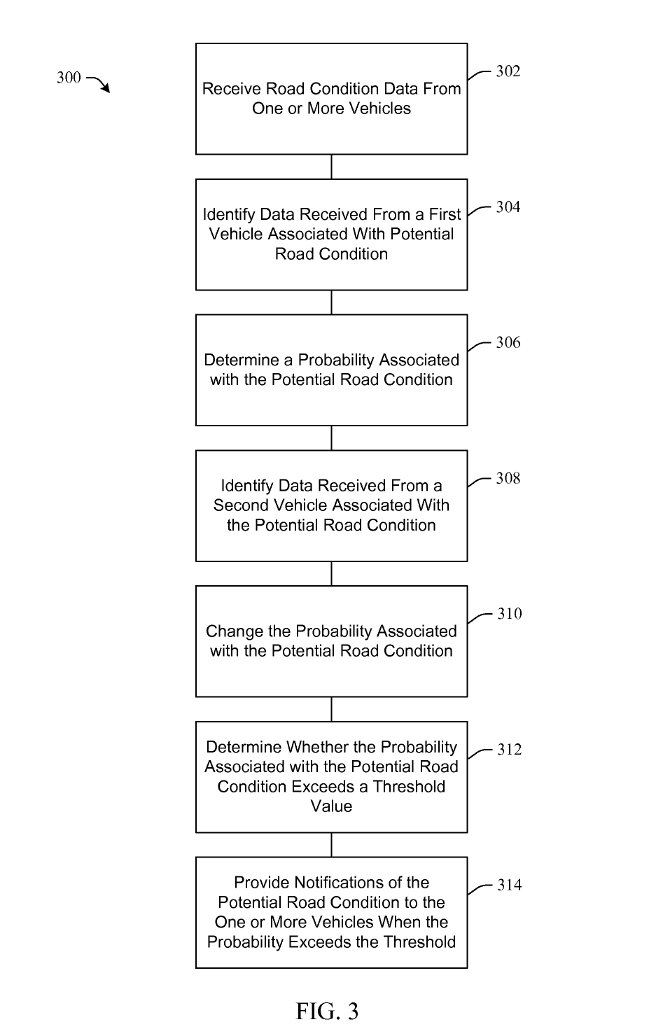

FIG. 3 illustrates a method 300 of identifying potential road conditions in accordance with aspects of the disclosure. The method can begin at 302 by receiving (e.g., at one or more remote servers 102, etc.) data associated with a location from one or more vehicles 106. Location data (e.g., via GPS, etc.) of the vehicles 106 can be used to determine the location of the potential road condition. This act of receiving can occur on an ongoing basis as vehicles 106 monitor data associated with the location and transmit at least a subset of that data. Next, at 304, at least a first subset of the data received from a first vehicle of the one or more vehicles 106 can be identified as associated with a potential road condition at the location.

In 306, the first subset of the data can be analyzed to determine a probability associated with the potential road condition. Optionally, in 308, at least a second subset of the data received from a second vehicle of the one or more vehicles 106 can be identified as associated with the potential road condition, for example, based on being associated with the same location. Then, in 310, if the second subset data was identified in 308, the second subset can be analyzed, and the probability associated with the potential road condition can be adjusted based at least in part on the analysis of the second subset, which can involve increasing or decreasing the probability, depending on whether the second subset of data indicates the presence or absence of the potential road condition.

Although not illustrated in FIG. 3, it is to be understood that data associated with the location can be received from additional vehicles 106 (e.g., a third vehicle, fourth vehicle, etc.), subsets of that data identified and analyzed, and the probability associated with the potential road condition can be adjusted based at least in part on that analysis. At 312, a determination can be made as to whether the probability associated with the potential road condition exceeds a threshold value. Then, at act 314, an alert or notification can be provided to at least one forthcoming vehicle of the one or more vehicles 106 upon approaching the location. The threshold can be arbitrarily set at 65% of vehicles passing in the area detecting the road condition.

It is to be understood that the acts of method 300 can occur on an ongoing basis and in connection with a plurality of locations; for example, data can be received from the at least one approaching vehicle, identified, and analyzed, and additional vehicles can be provided or not provided alerts or notifications, dependent upon whether the probability, which can be adjusted as data is received, is above the threshold. Additionally, other acts not illustrated in FIG. 3 can also be included in methods in accordance with aspects of the disclosure. For example, data collected from one or more sensors, or from sensors from one or more vehicles 106 can also be used to determine one or more categories of road conditions that most likely correspond to the potential road condition. An identification of one or more likely categories of road condition can be included in a notification or alert provided to vehicles 106. Additionally, data (e.g., photographic, video, etc.) associated with the potential road hazard can be provided in connection with the notification or alert, which can assist in driver recognition and avoidance of the condition (e.g., a photograph of a potential road condition could potentially include a pothole as well as one or more road features, etc. that can assist in avoiding the lane or specific location of the pothole, etc.).

In other aspects, the disclosure can provide improved determinations of the location of potential road conditions. In aspects, systems and methods of the disclosure can provide location information associated with a potential road condition having a greater level of accuracy (e.g., less uncertainty, margin of error, etc.) than location information from each of the vehicles 106 from which data is received to make such location determination. For example, a first vehicle 106 can identify a potential road condition at a location, but with a first level of uncertainty due to potential errors in location measurement. A second vehicle 106 can identify the same potential road condition at the location, with a second level of uncertainty, also due to potential errors in location measurement (in many situations, the first and second levels of uncertainty will be comparable). However, systems and methods of the disclosure can combine data from the first and second vehicles 106 to obtain a combined level of uncertainty that is less than either the first or second level of uncertainty via statistical and/or probabilistic analysis. As data from additional vehicles is received, the location of the potential road condition can be known with increasing certainty. In further aspects, this information can be combined with accurate mapping information to provide additional information on the location of potential road conditions to drivers of the one or more vehicles 106. For example, it can be determined which direction of traffic or which lane is most likely to encounter the potential road condition.

Data received from sensors associated with the one or more vehicles 106 can be analyzed in a variety of ways. As discussed herein, certain types of data or patterns of data can be indicative of increased probability of a potential road condition, such as vertical acceleration, cameras viewing potential potholes or objects in the road, etc. A probability can be estimated based on such data in any of a plurality of ways. For example, a library of data associated with potential road conditions as well as data not associated with potential road conditions can be assembled and can be used to determine a likelihood or probability that a potential road condition exists. In another example, training data can be collected with one or more vehicles in connection with known road conditions, and this training data can be used to train a classifier or similar algorithm (e.g., support vector machine, etc.) with data that is associated with road conditions as well as with data that is not associated with road conditions, such that future data can be analyzed to determine whether it is associated with potential road conditions. In a further example, training can occur at least in part on an ongoing basis.

The disclosure can employ various AI-based schemes for carrying out various aspects thereof. For example, a process for determining whether or not data is associated with a potential road condition can be facilitated via an automatic classifier system and process. A classifier is a function that maps an input attribute vector, x=(x1, x2, x3, x4, xn), to a confidence that the input belongs to a class, that is, f(x)=confidence(class). Such classification can employ a probabilistic and/or statistical-based analysis to prognose or infer whether data is associated with a potential road condition.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the disclosure can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria whether data is associated with a potential road condition.

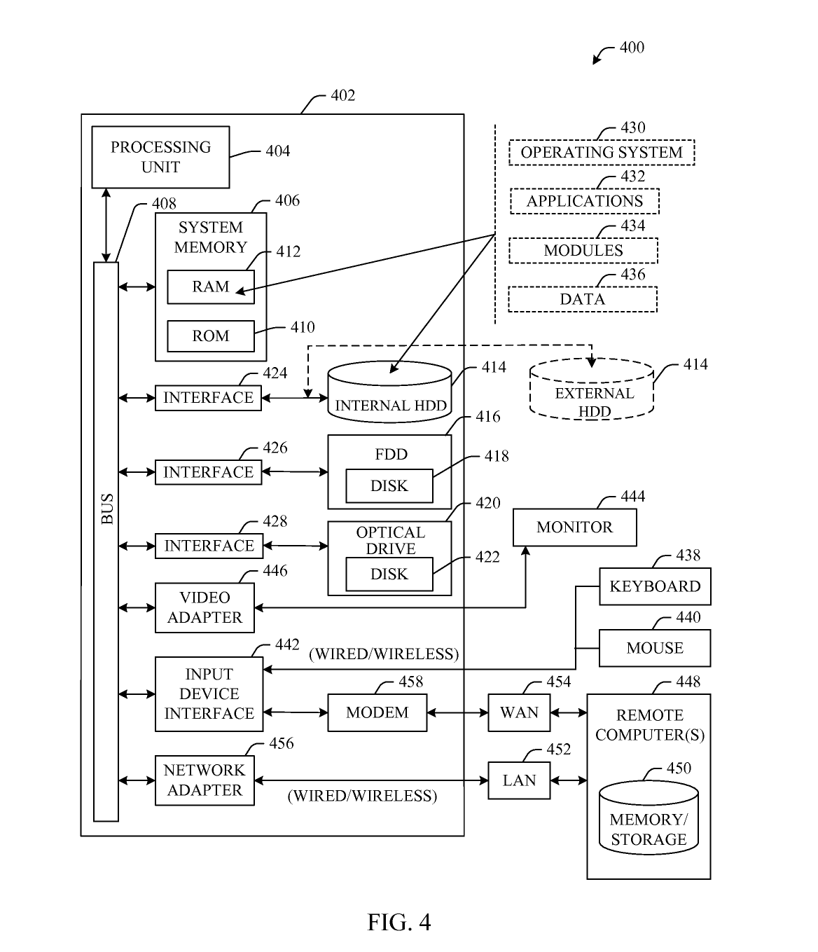

Referring now to FIG. 4, there is illustrated a block diagram of a computer operable to execute the disclosed architecture. In order to provide additional context for various aspects of the disclosure, FIG. 4 and the following discussion are intended to provide a brief, general description of a suitable computing environment 400 in which the various aspects of the disclosure can be implemented. While the disclosure has been described above in the general context of computer-executable instructions that may run on one or more computers, those skilled in the art will recognize that the disclosure also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the disclosure may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can include computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 4, the exemplary environment 400 for implementing various aspects of the disclosure includes a computer 402, the computer 402 including a processing unit 404, a system memory 406 and a system bus 408. The system bus 408 couples system components including, but not limited to, the system memory 406 to the processing unit 404. The processing unit 404 can be any of various commercially available processors. Dual microprocessors and other multi-processor architectures may also be employed as the processing unit 404.

The system bus 408 can be any of several types of bus structure that may further interconnect to a memory bus (with or without a memory controller), a peripheral bus, and a local bus using any of a variety of commercially available bus architectures. The system memory 406 includes read-only memory (ROM) 410 and random access memory (RAM) 412. A basic input/output system (BIOS) is stored in a non-volatile memory 410 such as ROM, EPROM, EEPROM, which BIOS contains the basic routines that help to transfer information between elements within the computer 402, such as during start-up. The RAM 412 can also include a high-speed RAM such as static RAM for caching data.

The computer 402 further includes an internal hard disk drive (HDD) 414 (e.g., EIDE, SATA), which internal hard disk drive 414 may also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The hard disk drive 414, magnetic disk drive 416 and optical disk drive 420 can be connected to the system bus 408 by a hard disk drive interface 424, a magnetic disk drive interface 426 and an optical drive interface 428, respectively. The interface 424 for external drive implementations includes at least one or both of Universal Serial Bus (USB) and IEEE 1394 interface technologies. Other external drive connection technologies are within contemplation of the disclosure.

The drives and their associated computer-readable media provide nonvolatile storage of data, data structures, computer-executable instructions, and so forth. For the computer 402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosure.

A number of program modules can be stored in the drives and RAM 412, including an operating system 430, one or more application programs 432, other program modules 434 and program data 436. All or portions of the operating system, applications, modules, and/or data can also be cached in the RAM 412. It is appreciated that the disclosure can be implemented with various commercially available operating systems or combinations of operating systems.

A user can enter commands and information into the computer 402 through one or more wired/wireless input devices, e.g., a keyboard 438 and a pointing device, such as a mouse 440. Other input devices (not shown) may include a microphone, an IR remote control, a joystick, a game pad, a stylus pen, touch screen, or the like. These and other input devices are often connected to the processing unit 404 through an input device interface 442 that is coupled to the system bus 408, but can be connected by other interfaces, such as a parallel port, an IEEE 1394 serial port, a game port, a USB port, an IR interface, etc.

A monitor 444 or other type of display device is also connected to the system bus 408 via an interface, such as a video adapter 446. In addition to the monitor 444, a computer typically includes other peripheral output devices (not shown), such as speakers, printers, etc.

The computer 402 may operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically includes many or all of the elements described relative to the computer 402, although, for purposes of brevity, only a memory/storage device 450 is illustrated. The logical connections depicted include wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which may connect to a global communications network, e.g., the Internet.

When used in a LAN networking environment, the computer 402 is connected to the local network 452 through a wired and/or wireless communication network interface or adapter 456. The adapter 456 may facilitate wired or wireless communication to the LAN 452, which may also include a wireless access point disposed thereon for communicating with the wireless adapter 456.

When used in a WAN networking environment, the computer 402 can include a modem 458, or is connected to a communications server on the WAN 454, or has other means for establishing communications over the WAN 454, such as by way of the Internet. The modem 458, which can be internal or external and a wired or wireless device, is connected to the system bus 408 via the serial port interface 442. In a networked environment, program modules depicted relative to the computer 402, or portions thereof, can be stored in the remote memory/storage device 450. It will be appreciated that the network connections shown are exemplary and other means of establishing a communications link between the computers can be used.

The computer 402 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

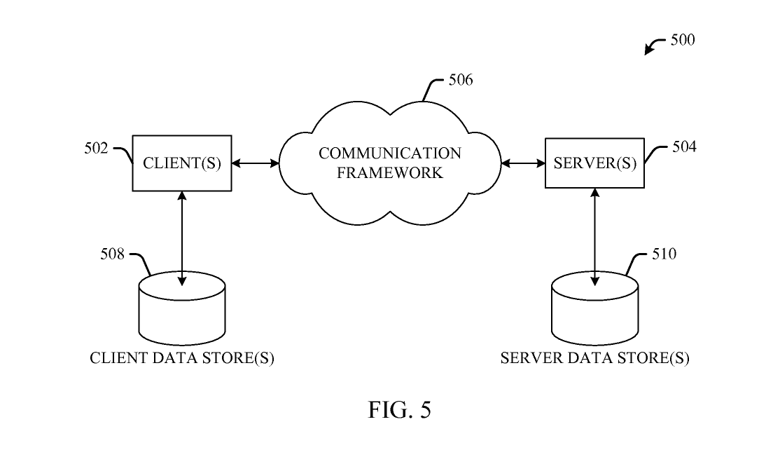

Referring now to FIG. 5, there is illustrated a schematic block diagram of an exemplary computing environment 500 in accordance with the disclosure. The system 500 includes one or more client(s) 502. The client(s) 502 can be hardware and/or software (e.g., threads, processes, computing devices). The client(s) 502 can house cookie(s) and/or associated contextual information by employing the disclosure, for example.

The system 500 also includes one or more server(s) 504. The server(s) 504 can also be hardware and/or software (e.g., threads, processes, computing devices). The servers 504 can house threads to perform transformations by employing the disclosure, for example. One possible communication between a client 502 and a server 504 can be in the form of a data packet adapted to be transmitted between two or more computer processes. The data packet may include a cookie and/or associated contextual information, for example. The system 500 includes a communication framework 506 (e.g., a global communication network such as the Internet) that can be employed to facilitate communications between the client(s) 502 and the server(s) 504.

Communications can be facilitated via a wired (including optical fiber) and/or wireless technology. The client(s) 502 are operatively connected to one or more client data store(s) 508 that can be employed to store information local to the client(s) 502 (e.g., cookie(s) and/or associated contextual information). Similarly, the server(s) 504 are operatively connected to one or more server data store(s) 510 that can be employed to store information local to the servers 504.

What has been described above includes examples of the disclosure. It is, of course, not possible to describe every conceivable combination of components or methodologies for purposes of describing the disclosure, but one of ordinary skill in the art may recognize that many further combinations and permutations of the disclosure are possible. Accordingly, the disclosure is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates identification of a potential road condition associated with a road surface, comprising:
one or more vehicles, wherein at least a first vehicle of the one or more vehicles collects data associated with the potential road condition via one or more sensors, wherein the data comprises an approximate location of the potential road condition; and
one or more remote servers, wherein the one or more remote servers receives a first subset of the data collected by the at least the first vehicle, wherein the one or more remote servers determines a probability associated with the potential road condition based at least in part on the first subset, and wherein the one or more remote servers provides a notification to at least a second vehicle when the probability exceeds a threshold value.

2. The system of claim 1, wherein the one or more sensors comprises one or more cameras.

3. The system of claim 1, wherein the one or more sensors comprises a G sensor capable of determining acceleration.

4. The system of claim 1, wherein the data comprises information indicating a time at which the data was obtained.

5. The system of claim 4, wherein the one or more remote servers give a greater weight to a more recent subset of the data in determining the probability than a weight given to a less recent subset of the data.

6. The system of claim 1, wherein the at least the first vehicle comprises two or more vehicles, and wherein the probability is based at least in part on data received from each of the two or more vehicles.

7. The system of claim 1, wherein the one or more remote servers notifies an entity responsible for maintenance of the road surface when the probability exceeds the threshold value.

8. The system of claim 1, wherein the notification comprises visual data associated with the potential road condition.

9. The system of claim 1, wherein the notification comprises a combined estimate of a location of the potential road condition, wherein the combined estimate is more accurate than the approximate location data.

10. A system that facilitates monitoring a road surface, comprising:
one or more cameras that record visual data of the road surface, wherein a subset of the visual data is associated with a first potential road condition on the road surface; and
a controller area network (CAN) that collects potential road condition data and provides the potential road condition data to one or more remote servers, wherein the potential road condition data comprises location data associated with the potential road condition and the subset of the visual data from the one or more cameras.

11. The system of claim 10, further comprising a G sensor that records acceleration data of a vehicle, wherein at least a subset of the acceleration data is associated with the first potential road condition, and wherein the potential road condition data comprises the subset of the acceleration data from the G sensor.

12. The system of claim 10, further comprising a user interface, wherein the CAN receives a notification of a second potential road hazard from the one or more remote servers, and wherein the CAN provides the notification to a driver of a vehicle via the user interface.

13. The system of claim 12, wherein the potential road condition data comprises one or more inputs received via the user interface.

14. The system of claim 12, wherein the notification comprises visual data associated with the second potential road hazard.

15. The system of claim 10, wherein the potential road condition data comprises time data associated with the subset of the visual data.

16. A method of detecting a potential road condition at a location on a road surface, comprising:
receiving a first set of data associated with the location on the road surface from a first vehicle;
identifying a first subset of the first set of data, wherein the first subset is associated with the potential road condition;
calculating a probability associated with the potential road condition based at least in part on the first subset;
determining whether the probability exceeds a threshold; and
notifying at least one vehicle of the potential road condition when the probability exceeds the threshold upon the at least one vehicle approaching the location.

17. The method of claim 16, further comprising:
receiving a second set of data associated with the location on the road surface from a second vehicle;
identifying a second subset of the second set, wherein the second subset is associated with the potential road condition; and
adjusting a probability associated with the potential road condition based at least in part on the second subset.

18. The method of claim 17, wherein the first subset comprises a first estimate of the location of the potential road condition and the second subset comprises a second estimate of the location of the potential road condition, and wherein the notification comprises a combined estimate of the location that is more accurate than the first estimate and the second estimate.

19. The method of claim 16, wherein the notification comprises visual data associated with the potential road condition.

20. The method of claim 16, further comprising notifying an entity associated with maintenance of the road surface when the probability exceeds the threshold.
